(19) United States
(12) Patent Application Publication
(10) Pub. No.: US 2012/0203549 A1
(43) Pub. Date: Aug. 9, 2012

(54) NOISE REJECTION APPARATUS, NOISE REJECTION METHOD AND NOISE REJECTION PROGRAM

(75) Inventor: Joji NAITO, Zushi-shi (JP)

(73) Assignee: JVC KENWOOD Corporation a corporation of Japan, Yokohama-Shi (JP)

(21) Appl. No.: 13/366,395

(22) Filed: Feb. 6, 2012

(30) Foreign Application Priority Data
Feb. 7, 2011 (JP) 2011-024403

(51) Int. Cl. G10L 15/20

(52) U.S. Cl. 704/233; 704/E15.039

(57) ABSTRACT

A speech-segment determination process is performed to determine whether audio data is a speech segment. A result of the speech-segment determination process is memorized. A noise rejection process is performed to reject a noise component of the audio data while performing an adaptive process to change filter coefficients for adaptive filtration if a result of the determination process indicates that the audio data is not the speech segment. The noise component is rejected with no adaptive process if the result of the determination process indicates that the audio data is the speech segment. The determination process is performed again to the audio data having the noise component rejected and the rejection process is performed again to the audio data if a result of the determination process performed again is different from the memorized result of the determination process.

### CROSS-REFERENCE TO RELATED APPLICATIONS

This application is based on and claims the benefit of priority from the prior Japanese Patent Application No. 2011-024403 filed on Feb. 7, 2011, the entire content of which is incorporated herein by reference.

### BACKGROUND OF THE INVENTION

The present invention relates to a noise rejection apparatus, a noise rejection method, and a noise rejection program for rejecting noise components from audio data of a captured sound.

Audio data based on a sound captured by a microphone includes voices to be captured and acoustic noises (referred as merely noises, hereinafter), hence subjected to lower data quality with lowered sound quality.

An adaptive filter is used in extraction of audio data with noise rejection in a first known technique. In this known technique, an adaptive filter halts an adaptation process to change the filter coefficients to raise adaptive accuracy to noises during the period of a speech segment. Determination of whether audio data mainly includes speech segments is made based on the difference in power in a short time between voices and noises in a second known technique. The start and end points of audio data that mainly includes speech segments are determined based on a spectrum of audio data in a third known technique.

However, the second and third known techniques are disadvantageous in that erroneous determination is sometimes made between speech and non-speech segments in an environment with much noise. In the first known technique, an adaptive filter is required to continue an adaptation process to change the filter coefficients for noise components of audio data based on a sound captured by a microphone, depending on the environment. In detail, the adaptation process has to be continued when the transfer characteristics between a noise source and a microphone changes with the elapse of time. However, if there is erroneous determination between speech and non-speech segments, it may happen that a non-speech segment cannot be detected having an enough length for an adaptation process, an adaptive filter erroneously self-adjusts the filter coefficients for audio data including a speech segment, etc. This may result in inadequate noise rejection.

### SUMMARY OF THE INVENTION

A purpose of the present invention is to provide a noise rejection apparatus, a noise rejection method, and a noise rejection program with high accuracy of speech segment determination and noise rejection with no increase in processing load.

The present invention provides a noise rejection apparatus comprising: a speech-segment determination unit configured to perform a speech-segment determination process to determine whether audio data having a specific length and carried by an input signal is a speech segment or a non-speech segment; a parameter storage unit configured to store at least a result of the speech-segment determination process; and a noise rejection unit having an adaptive filter and configured to perform a noise rejection process to reject a noise component of the audio data while the adaptive filter is performing an adaptive process to change filter coefficients if a result of the speech-segment determination process indicates that the audio data is the non-speech segment whereas to reject the noise component of the audio data while the adaptive filter is not performing the adaptive process if the result of the speech-segment determination process indicates that the audio data is the speech segment, wherein the speech-segment determination unit performs again the speech-segment determination process to the audio data having the noise component rejected and the noise rejection unit performs again the noise rejection process to the audio data if a result of the speech-segment determination process performed again is different from the result of the speech-segment determination process stored in the parameter storage unit.

Moreover, the present invention provides a noise rejection method comprising the steps of: performing a speech-segment determination process to determine whether audio data having a specific length and carried by an input signal is a speech segment or a non-speech segment; memorizing at least a result of the speech-segment determination process; and performing a noise rejection process to reject a noise component of the audio data while performing an adaptive process to change filter coefficients for adaptive filtration if a result of the speech-segment determination process indicates that the audio data is the non-speech segment whereas rejecting the noise component of the audio data with no adaptive process if the result of the speech-segment determination process indicates that the audio data is the speech segment, wherein the speech-segment determination process is performed again to the audio data having the noise component rejected and the noise rejection process is performed again to the audio data if a result of the speech-segment determination process performed again is different from the memorized result of the speech-segment determination process.

Furthermore, the present invention provides a noise rejection program stored in a non-transitory computer readable storage medium, comprising: a program code of performing a speech-segment determination process to determine whether audio data having a specific length and carried by an input signal is a speech segment or a non-speech segment; a program code of memorizing at least a result of the speech-segment determination process; and a program code of performing a noise rejection process to reject a noise component of the audio data while performing an adaptive process to change filter coefficients for adaptive filtration if a result of the speech-segment determination process indicates that the audio data is the non-speech segment whereas rejecting the noise component of the audio data with no adaptive process if the result of the speech-segment determination process indicates that the audio data is the speech segment, wherein the speech-segment determination process is performed again to the audio data having the noise component rejected and the noise rejection process is performed again to the audio data if a result of the speech-segment determination process performed again is different from the memorized result of the speech-segment determination process.

### BRIEF DESCRIPTION OF DRAWINGS

FIG. 1 is a functional block diagram of a schematic configuration of an embodiment of a noise rejection apparatus according to the present invention;

FIG. 2 is a functional block diagram showing a schematic configuration of a noise rejection unit according to the present invention;

FIG. 3 is a view showing an exemplary schematic configuration of an adaptive filter according to the present invention;

FIG. 4 shows a flow chart of the entire process performed by the noise rejection apparatus according to the present invention; and

FIG. 5 shows a timing chart of respective processes to be carried out for sequential input frames.

### DETAILED DESCRIPTION OF PREFERRED EMBODIMENTS

Preferable embodiments according the present invention will be explained with reference to the attached drawings.

(Noise Rejection Apparatus)

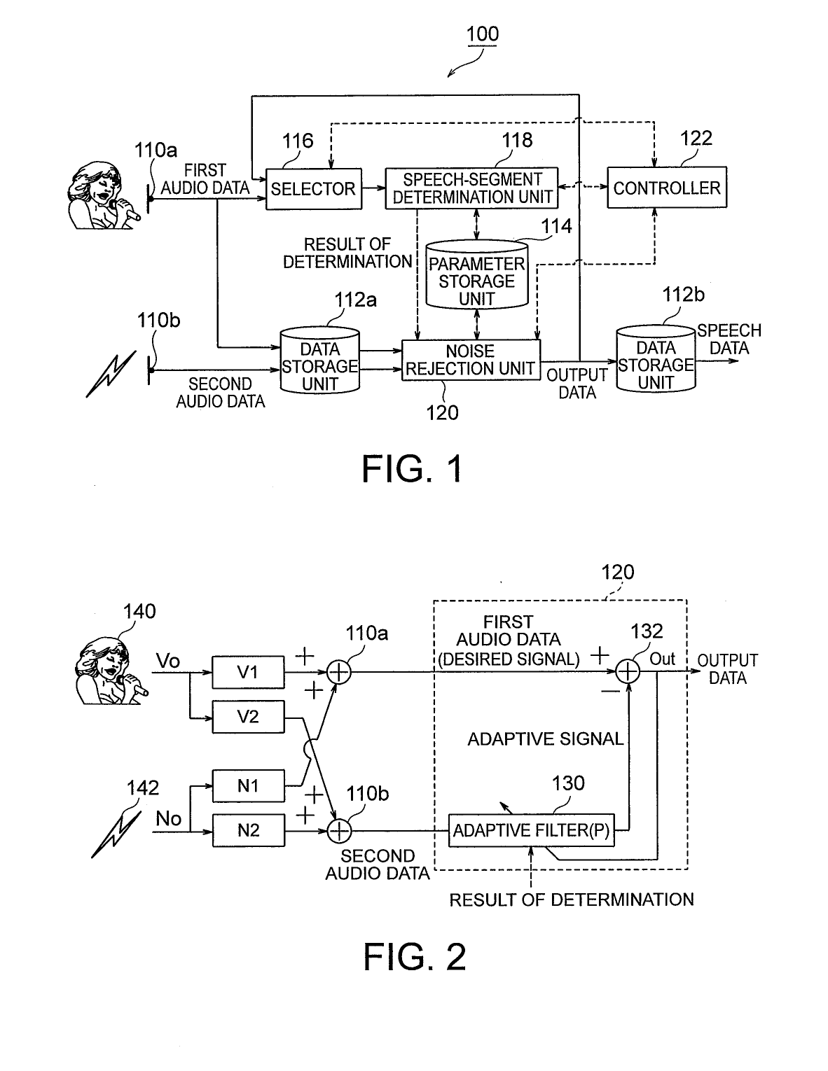

FIG. 1 is functional block diagram representing a schematic configuration of a noise rejection apparatus 100, an embodiment of the present invention.

As shown in FIG. 1, the noise rejection apparatus 100 is provided with microphones 110a and 110b, data storage units 112a and 112b, a parameter storage unit 114, a selector 116, a speech-segment determination unit 118, a noise rejection unit 120, and a controller 122.

In FIG. 1, a solid line represents a flow of data such as audio data and a broken represents a flow of a control signal, a parameter, etc.

The microphones 110a and 110b are equipment for converting a physical vibration into an electrical signal. Especially, in this embodiment, the microphones 110a and 110b capture surrounding sounds and convert the sounds into audio signals. Moreover, in this embodiment, the microphones 110a and 110b are set in different places for mainly capturing voices and noises, respectively. Microphones that can be used as the microphones 110a and 110b are any types of microphone that can convert the vibration of a transfer medium, such as, a condenser microphone, a dynamic microphone, a ribbon microphone, a piezo electric microphone, and a carbon microphone.

The audio signals output from the microphones 110a and 110b are converted by an AD converter (not shown) into audio data of 256 samples for each one frame. The audio data are first audio data from the microphone 110a and second audio data from the microphone 110b. The first and second audio data are stored in the data storage unit 112a.

The first and second audio data stored in the data storage unit 112a are sent to the noise rejection unit 120. The first audio data then undergoes a noise rejection process which will be described later. The first audio data having noise components rejected is sent to the data storage unit 112b. The data storage units 112a and 112b are a storage medium, such as a flash memory and an HDD (Hard Disk Drive), for temporally storing the first and second audio data and those having noise components rejected, respectively.

The first audio data having noise components rejected by the rejection unit 120 is also sent to the selector 116. The first audio data obtained from the sound captured by the microphone 110a thus having noise components is also sent to the selector 116. The selector 116 selects either the first audio data having noise components or the first audio data having noise components rejected, in response to a control signal from the controller 122 which will be described later. The first audio data with noise components or without noise components selected by the selector 116 is sent to the speech-segment determination unit 118.

The speech-segment determination unit 118 determines whether the audio data having a predetermined length (one frame in this embodiment) output from the selector 116 is a speech segment or a non-speech segment. This determination is referred as a speech-segment determination process. The detailed explanation of the speech-segment determination process is omitted because it can be achieved with a variety of known techniques. For, example, the speech-segment determination process is performed based on: the difference in power (energy) in a short time between a speech component and a noise component; or the frequency characteristics, the spectrum of the audio data.

The result of the speech-segment determination process is then stored in the parameter storage unit 114 that is a storage medium, such as, a flash memory and an HDD. Also stored in the parameter storage unit 114 are parameters (such as, filter coefficients and values of shifter registers) of an adaptive filter of the noise rejection unit 120.

The result of the speech-segment determination is also sent to the noise rejection unit 120. Also sent to the noise rejection unit 120 are the first and second audio data stored in the data storage unit 112a. The noise rejection unit 120 is equipped with an adaptive filter that performs a noise rejection process. In this process, the adaptive filter performs an adaptation process to change the filter coefficients for noise components carried by the first data (obtained based on the sound captured by the microphone 110a) based on the second audio data. The adaptation process cancels the noise components between the first audio data and the second audio data based on which the noise components of the first audio data are applied with the adaptation process. Accordingly, in this noise rejection process, the noise components are rejected from the first audio data and speech data is extracted therefrom.

In the noise rejection unit 120, the adaptation process of the adaptive filter depends on whether the audio data having a predetermined length (one frame in this embodiment) output from the selector 116 is determined as a speech segment or a non-speech segment by the speech-segment determination unit 118. In detail, if the audio data output from the selector 116 is determined as a non-speech segment, the noise rejection unit 120 rejects noise components of the audio data having a predetermined length while the adaptive filter 130 changes the filter coefficients. On the other hand, if the audio data output from the selector 116 is determined as a speech segment, the noise rejection unit 120 rejects noise components of the audio data having a predetermined length while the adaptive filter 130 does not change the filter coefficients. In this way, the adaptive filter performs the adaptation process only for the noise components of the first audio data obtained from the sound captured by the microphone 110a, which will be explained later in detail. The parameters of the adaptive filter for the adaptation process are sent from the noise rejection unit 120 to the parameter storage unit 114 and stored therein for each predetermined data length (one frame in this embodiment).

The speech-segment determination unit 118 and the noise rejection unit 120 are under control by the controller 122 that includes a semiconductor circuit having a ROM with a program stored therein and a RAM as a work area. In the control, after the first-time speech-segment determination process, the controller 122 controls the speech-segment determination unit 118 to perform the speech-segment determination process again (the second-time speech-segment determination process) to the audio data from which noise components have been rejected in the first-time noise rejection process. Then, if the result of the second-time speech-segment determination process is different from the result of the first-time speech-segment determination process stored in the parameter storage unit 114, the controller 122 controls the noise rejection unit 120 to perform the noise rejection process again. The control of the speech-segment determination unit 118 and the noise rejection unit 120 by the controller 122 will be described later in detail.

(Noise Rejection Process)

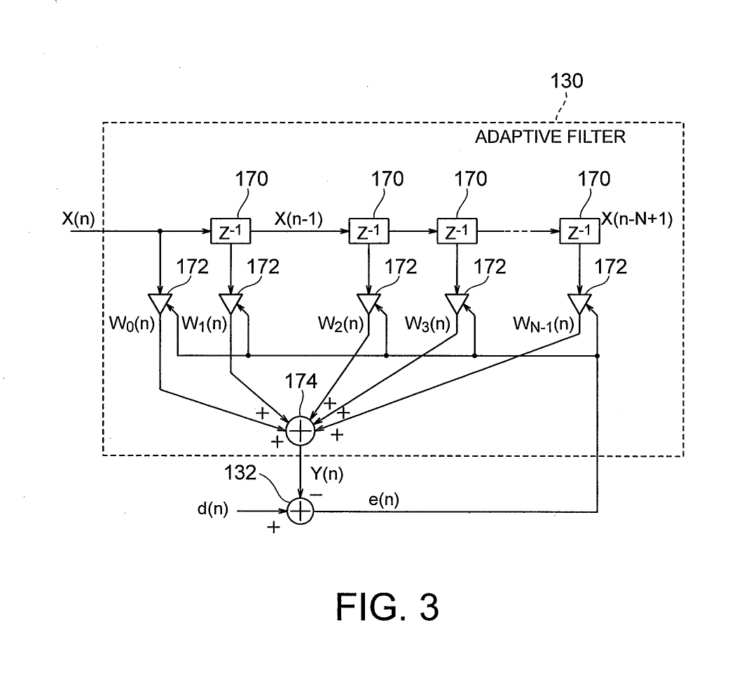

The noise rejection process to be performed by the noise rejection unit 120 is described in detail with reference to FIGS. 2 and 3.

FIG. 2 is a functional block diagram showing a schematic configuration of the noise rejection unit 120. In FIG. 2, the noise rejection unit 120 is provided with an adaptive filter 130 and a subtracter 132. With reference to FIG. 2, the noise rejection process is described with the data storage unit 112a (FIG. 1) omitted for easier understanding, that functions as a buffer for the first and second audio data.

The two microphones 110a and 110b connected to the noise rejection apparatus 100 are set in different places. Therefore, in FIG. 2, the acoustic transfer characteristics from a voice source 140 and a noise source 142 to the microphones 110a and 110b are different from each other.

The noise rejection process in this embodiment presumes and cancels the acoustic transfer characteristics from the noise source 142 based on the difference in acoustic transfer characteristics discussed above, to extract a speech segment from the sound of the voice source 140.

In FIG. 2: signs Vo and No denote a voice from the voice source 140 and a noise from the noise source 142, respectively; signs V1 and V2 denote the transfer characteristics of a voice from the voice source 140 to the microphones 110a and 110b, respectively; and signs N1 and N2 denote the transfer characteristics of a noise from the noise source 142 to the microphones 110a and 110b, respectively.

Then, the output data Out of the noise rejection unit 120 is expressed by an equation (1) below:

Out=V1·Vo+N1·No−P(V2·Vo+N2·No)=(V1−P·V2)V0+(N1−P·N2) (1)

where P is the transfer characteristics of the adaptive filter 130.

It is tried to identify, by the adaptive filter 130 (with the transfer characteristics P), the difference N1/N2 in the transfer characteristics from the noise source 142 to the microphones 110a and 110b, as an unknown system. Only when the voice Vo is zero (only when a result of determination by the speech-segment determination unit 118 indicates a non-speech segment), the adaptive filter 130 performs an adaptation process (a learning process) to have minimum output data Out, which results in adaptation of the transfer characteristics P to N1/N.

With the adaptation of the transfer characteristics P to N1/N, the second term in the equation (1) becomes close to zero to give the output data Out after the adaptation Out=(V1−N1/N2·N2)Vo which indicates that a speech segment carries a voice only whereas a non-speech segment has noise component suppressed.

In FIG. 2, the first audio data obtained from a sound captured by the microphone 110a is a desired signal of the adaptive filter 130 and the second audio data obtained from a sound captured by the microphone 110b is a signal to undergo adaptive filtration by the adaptive filter 130. The subtracter 132 subtracts from the desired signal an adaptive signal from the adaptive filter 130 to obtain the output data Out. In this process, the adaptive filter 130 receives the second audio data as a reference input signal (at the left terminal of the adaptive filter 130 in FIG. 2) and the output data of the subtracter 132 as an adaptive error (at the terminal indicated by an oblique line in the adaptive filter 130 in FIG. 2). With these input signals, the adaptive filter 130 self-adjusts its filter coefficients adaptively to have a minimum adaptive error (output data). This process corresponds to the adaptation process described above.

FIG. 3 is a view showing an exemplary schematic configuration of the adaptive filter 130. In FIG. 3, the adaptive filter 130 employs the LMS (Least Mean Square) algorism to have a least mean square error based on the steepest descent method, as an adaptive filtering algorism. The adaptive filter 130 includes shift registers 170, multipliers 172, and an adder 174, in FIG. 3.

FIG. 3 illustrates that a reference input signal X(n) corresponding to the second audio data at a given sampling time n (n being an integer) is shifted by the shift registers 170, each for shifting an input signal in a predetermined sampling period, to become a train of signals X(n)˜X(n−N+1) with a given time difference between adjacent signals. The letter N indicates the number of stages of the shift registers 170, for example, 256 stages in this embodiment. The train of signals X(n)˜X(n−N+1) are supplied to the N stages of multiplies 172 and multiplied by filter coefficients W₀(n)˜W_{N-1}(n), respectively. The results of multiplication are then added to one another by the adder 174 to be an output signal (an adaptive signal) Y(n).

The adaptive signal) Y(n) is expressed by an equation (2) shown below, with convolution of the reference input signals X(n)˜X(n−N+1) and the filter coefficients W₀(n)˜W_{N-1}(n).

$$Y ( n ) = {\sum }_{i = 0}^{N - 1} {W}_{i} ( n ) X ( n - i ) \qquad ( 2 )$$

The adaptive signal Y(n) output from the adaptive filter 130 is supplied to the subtracter 132 and subtracted from a desired signal d(n) corresponding to the first audio data to obtain an adaptive error input e(n). The adaptive error input e(n) corresponds to the output data Out (FIG. 2), in accordance with an equation (3) shown below.

e(n)=d(n)−Y(n) (3)

The filter coefficients W₀(n)˜W_{N-1}(n) are updated to have a minimum adaptive error input e(n), in accordance with an equation (4) shown below.

W(n+1)=W(n)+2μ·e(n)·X(n) (4).

The value μ in the equation (4) is a step-size parameter that decides the speed of updating and the accuracy of convergence, which can be selected appropriately from the statistical characteristics of a reference input signal. The step-size parameter μ is usually in the range from about 0.01 to 0.001.

In addition to the LMS algorism described above, the adaptive filter 130 can use any known algorism as the adaptive filtering algorism, such as, RLMS (Recursive LMS) and NLMS (Normalized LM).

As described above in detail, the adaptive filter 130 can identify the difference N1/N2 in the acoustic (transfer) characteristics from the noise source 142 to the microphones 110a and 110b, as an unknown system, with adaptive updating of the filter coefficients W₀(n)˜W_{N-1}(n). The identification results in suppression of noise components carried by the output data Oout after the adaptation, hence audio data is only extracted from the first audio data.

Returning to FIG. 1, on completion of the noise rejection process described above, the noise rejection unit 120 stores parameters that are the filter coefficients W₀(n)˜W_{N-1}(n) and the values of the shift registers 170 (FIG. 3) in the parameter storage unit 114, as associated with a frame number of the succeeding frame to be processed in the input audio data. The parameters are necessary for the repetition of the noise rejection process, which will be described later.

(Noise Rejection Method)

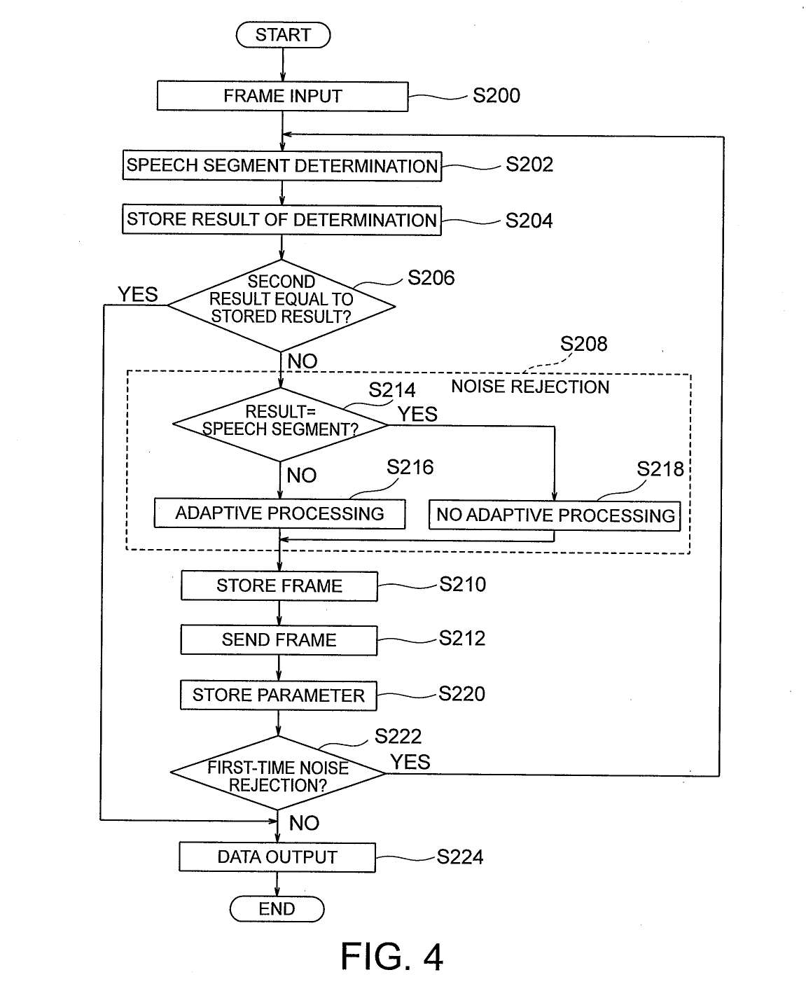

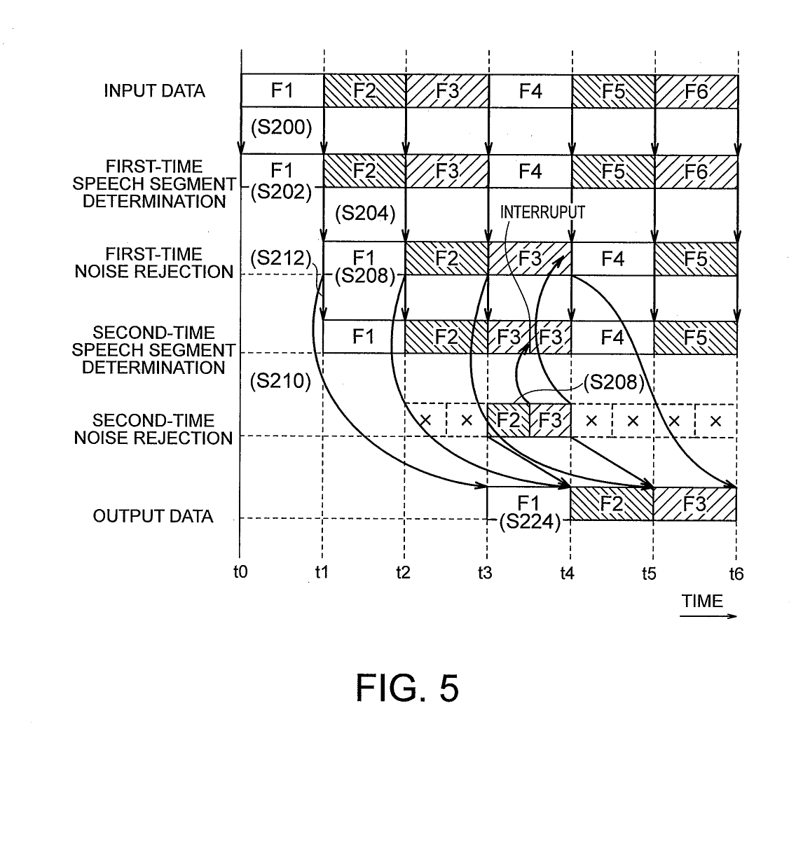

A noise rejection method according to the present invention is described with reference to FIGS. 4 and 5. FIG. 4 shows a flow chart of the entire process performed by the noise rejection apparatus 100. FIG. 5 shows a timing chart of respective processes to be carried out for sequential input frames F1 to F6 in parallel, in a so-called a pipeline process.

In the pipeline process, for example, the second-time speech determination process for a frame F1 and the first-time speech determination process for a frame F2 next to the frame F1 are performed in parallel. It is a precondition in this example that a result of a speech-segment determination process is reflected in a noise rejection process with no delay, for the simplicity in explanation with reference to FIGS. 4 and 5. Moreover, it is a precondition in this example that the speech-segment determination process and the noise rejection process are repeated two times at maximum (although the processes can be repeated more than two times), for the simplicity of the explanation. A further precondition in this example is that the first- and second-time speech determination processes give the same result to the frame F1 whereas different results to the frame F2.

With reference to FIGS. 4 and 5, the frame F1 of the first audio data obtained from a sound capture by the microphone 110a is stored in the data storage unit 112a and input to the speech-segment determination unit 118 via the selector 116 (step S200). The speech-segment determination unit 118 performs the first-time speech determination process to the frame F1 (step S202), and stores a result of determination to the parameter storage unit 114 and sends the result to the noise rejection unit 120 (step S204).

Then, the controller 122 determines whether the speech determination process performed to a frame of interest is the second-time speech determination process and whether a result of determination of the second-time speech determination process is equal to the result of determination of the first-time speech determination process that has been stored in the parameter storage unit 114 (step S206).

The speech determination process performed to the frame F1 is the first-time speech determination process at this stage (No in step S206). Therefore, the noise rejection unit 120 retrieves the parameters associated with the frame F1 (the initial parameters in the case of the frame F1) from the parameter storage unit 114 and performs the noise rejection process to the frame F1 (step S208), which will be described later. And then, the noise rejection unit 120 stores the frame F1 having a noise component rejected in the data storage unit 112b (step S210). Moreover, since the noise rejection process was performed in step S208 for the first time, the noise rejection unit 120 sends the frame F1 having a noise component rejected to the speech-segment determination unit 118 via the selector 116 (step S212).

In the noise rejection process (step S208), the noise rejection unit 120 determines whether the result of determination at the speech-segment determination unit 118 indicates a speech segment (step S214). If the result of determination does not indicate a speech segment (No in step S214), the noise rejection unit 120 performs the noise rejection process with the adaptation process at the adaptive filter 130 (step S216). On the other hand, if the result of determination indicates a speech segment (Yes in step S214), the noise rejection unit 120 performs the noise rejection process with the adaptation process halted at the adaptive filter 130 (step S218). The difference in steps S216 and S218 is whether the adaptation process is performed or not. The noise rejection process is performed irrespective of whether the result of determination indicates a speech segment or not.

Once steps S208, S210 and step S212 are complete, the noise rejection unit 120 stores the filter coefficients W₀(n)˜W_{N-1}(n) and the values of the shift registers 170 in the parameter storage unit 114, as the parameters of the noise rejection unit 120 and as associated with a frame number of a frame to be processed next (the frame F2 in this example), for the second-time noise rejection process. The data length to be stored in the parameter storage unit 114 is determined by a product of the number of delayed frames in the speech-segment determination process, the noise rejection process, etc. and the number of times of the processes. In this embodiment, the data length to be stored in the parameter storage unit 114 corresponds to two frames.

It is then determined whether the noise rejection process (step S208) for the frame F1 is the first time (step S222). If it is the first time (Yes in step S222), in parallel with the first-time noise rejection process (step S208) for the frame F1, the speech-segment determination unit 118 determines again (the second-time speech-segment determination process) whether the frame F1 that has been sent via the selector 116 and has undergone the first-time noise rejection process is a speech segment (step S202). The second-time speech-segment determination process is performed to the frame F1 having a noise component rejected by the first-time noise rejection process, thus achieving more accurate and reliable speech-segment determination.

Suppose that a result of the second-time speech-segment determination process (step S202) is the same as the result of the first-time speech-segment determination process. In this case, it is determined (step S206) that the speech-segment determination process for a frame of interest is the second time and a result of the second-time determination process at the speech-segment determination unit 118 is the same as the result of the first-time determination process stored in the parameter storage unit 114.

As described above, it is the precondition in this example that the first- and second-time speech determination processes give the same result to the frame F1. According to the precondition, it is determined (Yes in step S206) that the speech-segment determination process for the frame F1 is the second time and a result of the second-time determination process at the speech-segment determination unit 118 is the same as the result of the first-time determination process stored in the parameter storage unit 114. In this case, the second-time noise rejection process (step S208) is not performed to the frame F1, for the following reason.

When the results of the first- and second-time speech-segment determination processes are the same as each other, the determination of whether to perform the adaptation process at the adaptive filter 130 is also the same as each other. In detail, if both of the results of the first- and second-time speech-segment determination processes do not indicate a speech segment (No in step S214), the noise rejection unit 120 performs the noise rejection process with the adaptation process at the adaptive filter 130 (step S216). On the other hand, if both of the result of determination indicate a speech segment (Yes in step S214), the noise rejection unit 120 performs the noise rejection process with the adaptation process halted at the adaptive filter 130 (step S218).

In this case, a result of the second-time noise rejection process becomes the same as that of the first-time noise rejection process even if the second-time process is performed. Accordingly, when the results of the first- and second-time speech-segment determination process are the same as each other, the use of the result of the first-time noise rejection process is equivalent to the execution of the second-time noise rejection process even if the second-time noise rejection process is not performed.

Accordingly, only when the results of the first- and second-time speech-segment determination processes are different from each other, the second-time noise rejection process (step S208) is performed to yield favorable effects, thus achieving the reduction in process load.

Through these steps, if the noise rejection process (step S208) is the second time (No in step S222) or the second-time noise rejection process (step S208) is not performed (Yes in step S206), the controller 122 outputs the output data stored in the data storage unit 112b (step S224).

Described next are the processes for the frame F2. Suppose that, for the frame F2, although a result of the first-time speech-segment determination process indicates a speech segment, that of the second-time determination process indicates a non-speech segment (according to the precondition in this example that the first- and second-time speech determination processes give different results to the frame F2).

Under the supposition for the frame F2, it is determined that a result of determination of the second-time speech determination process for the frame F2 is different from the result of determination of the first-time speech determination process that has been stored in the parameter storage unit 114 (No step S206). Therefore, the second-time noise rejection process is performed to the frame F2 (step S208), as shown in FIG. 5.

In the second-time noise rejection process for the frame F2, the filter coefficients W₀(n)˜W_{N-1}(n) and the values of the shift registers 170 stored in the parameter storage unit 114 before the second-time noise rejection process for the frame F2 are set again and the frame F2 is retrieved from the data storage unit 112a. In parallel with the second-time noise rejection process for the frame F2, the first-time noise rejection process is performed to the frame F3, as the pipeline process.

The first-time noise rejection process for the frame F3 (in parallel with the second-time noise rejection process for the frame F2) is, however, performed with the filter coefficients W₀(n)˜W_{N-1}(n) and the values of the shift registers 170 based on the result of the first-time noise rejection process for the frame F2. Thus, the first-time noise rejection process for the frame F3 may not yield a favorable result. Therefore, as shown in FIG. 5, following to the second-time noise rejection process for the frame F2, the first-time noise rejection process is performed again to the frame F3 as the second-time noise rejection process, with the filter coefficients W₀(n)˜W_{N-1}(n) and the values of the shift registers 170 based on the result of the second-time noise rejection process for the frame F2.

Accordingly, as shown in FIG. 5, for the first-time noise rejection process for the frame F4, the filter coefficients W₀(n)˜W_{N-1}(n) and the values of the shift registers 170 are set based on the result of the second-time noise rejection process for the frame F3 (more specifically, the results of the second-time noise rejection processes for the frames F2 and F3).

The sequential processes shown in FIG. 5 are described more in detail.

Suppose that the second-time speech-segment determination process has been performed to the frame F2 in a time frame (t2-t3) and the second-time noise rejection process is required for the frame F2.

In this case, in the next time frame (t3-t4), the first-time speech-segment determination process is performed to the frame F4, which is followed by the first-time noise rejection process for the frame F3, according to the sequence. However, the noise rejection process for the frame F3 requires the filter coefficients and shift-register values not updated at the time of the first-time noise rejection process for the frame F2 but updated at the time of the second-time noise rejection process for the frame F2. Therefore, the first-time noise rejection process for the frame F3 is interrupted or not performed. Then, in the next time frame (t3-t4), the second-time noise rejection process is performed to the frame F2, which is followed by the second-time noise rejection process for the frame F3. Accordingly, even though the pipeline process is employed, the result of the second-time noise rejection process can be accurately reflected to the succeeding processes.

As described above in detail, the noise rejection apparatus 100 can accurately perform the speech-segment determination process even in an environment with much noise, by mutual use of results between the speech-segment determination process and the noise rejection process. Moreover, the mutual use of results allows an accurate noise rejection process with almost no decrease in sound quality. Furthermore, as described, the noise rejection process is performed only when the results of the first- and second-time speech-segment determination processes are different from each other in the case of the mutual use of results, which restricts the increase in processing load.

In the embodiment described above, the speech-segment determination process and the noise rejection process are performed two times at maximum. A larger number of times of these processes, however, gives higher accuracy while restricts the increase in processing load. This is because whether to perform the noise rejection process for the second time, the third time and so on is determined based on the result of the first- and second-time speech-segment determination processes.

Nevertheless, the increase in the number of times of the speech-segment determination process and the noise rejection process requires sequential processing of frames the number of which is proportional to the number of times of the processes, for each of the third-time and fourth-time noise rejection processes.

The increased number of times of the speech-segment determination process and the noise rejection process may not be set at a particular number. That is, the speech-segment determination process and the noise rejection process may be finished whenever the ratio of the number of times of yielding of different results between the first- and second-time speech-segment determination processes to the total number of times of the processes becomes within a specific ratio.

It is further understood by those skilled in the art that the foregoing description is a preferred embodiment of the disclosed device or method and that various changes and modifications may be made in the invention without departing from the spirit and scope thereof.

For example, the components of the noise rejection apparatus 100 shown in FIGS. 1 to 3 may be configured with hardware or software. In the case of hardware, the noise rejection apparatus 100 may be configured with digital components such as a digital filter, an adder, a subtracter, etc., or analog components such as an analog filter, an operational amplifier, etc. In the case of software, the noise rejection apparatus 100 may be configured with a program running on a computer. Such a program may be stored in a non-transitory computer readable storage medium.

As described above, the present invention provides a noise rejection apparatus, a noise rejection method, and a noise rejection program with high accuracy of speech segment determination and noise rejection with no increase in processing load

Moreover, as described above, the mutual use of results between the speech-segment determination process and the noise rejection process gives higher accuracy for these processes even in an environment with much noise.

Furthermore, as described, the noise rejection process is performed only when the results of the first- and second-time speech-segment determination processes are different from each other in the case of the mutual use of results, which restricts the increase in processing load.

What is claimed is:

1. A noise rejection apparatus comprising:
a speech-segment determination unit configured to perform a speech-segment determination process to determine whether audio data having a specific length and carried by an input signal is a speech segment or a non-speech segment;
a parameter storage unit configured to store at least a result of the speech-segment determination process; and
a noise rejection unit having an adaptive filter and configured to perform a noise rejection process to reject a noise component of the audio data while the adaptive filter is performing an adaptive process to change filter coefficients if a result of the speech-segment determination process indicates that the audio data is the non-speech segment whereas to reject the noise component of the audio data while the adaptive filter is not performing the adaptive process if the result of the speech-segment determination process indicates that the audio data is the speech segment,
wherein the speech-segment determination unit performs again the speech-segment determination process to the audio data having the noise component rejected and the noise rejection unit performs again the noise rejection process to the audio data if a result of the speech-segment determination process performed again is different from the result of the speech-segment determination process stored in the parameter storage unit.

2. The noise rejection apparatus according to claim 1, wherein the parameter storage unit stores a result of the adaptive process, and when the noise rejection unit performs again the noise rejection process, the noise rejection unit retrieves from the parameter storage unit a result of the adaptive process performed before a noise rejection process for the audio data that precedes the noise rejection process to be performed again.

3. The noise rejection apparatus according to claim 1, wherein a plurality of pieces of audio data having the specific length and carried by the input signal at different timing undergo in parallel the speech-segment determination process and undergo in parallel the noise rejection process.

4. A noise rejection method comprising the steps of:
performing a speech-segment determination process to determine whether audio data having a specific length and carried by an input signal is a speech segment or a non-speech segment;
memorizing at least a result of the speech-segment determination process; and
performing a noise rejection process to reject a noise component of the audio data while performing an adaptive process to change filter coefficients for adaptive filtration if a result of the speech-segment determination process indicates that the audio data is the non-speech segment whereas rejecting the noise component of the audio data with no adaptive process if the result of the speech-segment determination process indicates that the audio data is the speech segment,
wherein the speech-segment determination process is performed again to the audio data having the noise component rejected and the noise rejection process is performed again to the audio data if a result of the speech-segment determination process performed again is different from the memorized result of the speech-segment determination process.

5. The noise rejection method according to claim 4 further comprising the steps of:
memorizing a result of the adaptive process; and
when the noise rejection process is performed again, using a memorized result of the adaptive process performed before a noise rejection process for the audio data that precedes the noise rejection process to be performed again.

6. The noise rejection method according to claim 4, the speech-segment determination process is performed in parallel to a plurality of pieces of audio data having the specific length and carried by the input signal at different timing and the noise rejection process is performed in parallel to the plurality of pieces of audio data.

7. A noise rejection program stored in a non-transitory computer readable storage medium, comprising:
a program code of performing a speech-segment determination process to determine whether audio data having a specific length and carried by an input signal is a speech segment or a non-speech segment;
a program code of memorizing at least a result of the speech-segment determination process; and
a program code of performing a noise rejection process to reject a noise component of the audio data while performing an adaptive process to change filter coefficients for adaptive filtration if a result of the speech-segment determination process indicates that the audio data is the non-speech segment whereas rejecting the noise component of the audio data with no adaptive process if the result of the speech-segment determination process indicates that the audio data is the speech segment,
wherein the speech-segment determination process is performed again to the audio data having the noise component rejected and the noise rejection process is performed again to the audio data if a result of the speech-segment determination process performed again is different from the memorized result of the speech-segment determination process.

8. The noise rejection program according to claim 7 further comprising:
a program code of memorizing a result of the adaptive process; and
when the noise rejection process is performed again, a program code of using a memorized result of the adaptive process performed before a noise rejection process for the audio data that precedes the noise rejection process to be performed again.

9. The noise rejection program according to claim 7, wherein the speech-segment determination process is performed in parallel for a plurality of pieces of audio data having the specific length and carried by the input signal at different timing and the noise rejection process is performed in parallel to the plurality of pieces of audio data.
